(19) United States
(12) Patent Application Publication
(10) Pub. No.: US 2021/0108445 A1
(43) Pub. Date: Apr. 15, 2021

(54) KEY ASSEMBLY

(71) Applicant: YU-PIN LIN, TAINAN (TW)

(72) Inventor: YU-PIN LIN, TAINAN (TW)

(73) Assignee: YU-PIN LIN, TAINAN (TW)

(21) Appl. No.: 16/653,984

(22) Filed: Oct. 15, 2019

(51) Int. Cl. E05B 19/04

(52) U.S. Cl. CPC E05B 19/04

(57) ABSTRACT

A key assembly includes a shank and a handle portion. The handle portion includes a free end and connection end from which the shank extends. The shank includes multiple grooves. A tubular portion is connected to connection end of the handle portion and a portion of the shank is accommodated in the tubular portion. The length from the distal end of the tubular portion to the distal end of the shank is the same as the depth from the key hole to the inner bottom of the lock cylinder. When the shank of the key assembly is inserted into the lock cylinder and reaches the inner bottom of the lock cylinder, the distal end of the tubular portion contacts the lock.

### BACKGROUND OF THE INVENTION

### 1. Fields of the Invention

The present invention relates to a key assembly for rotating a lock cylinder, and more particularly, to a key assembly that includes a key coat connected thereto so as to acknowledge the user that the shank of the key is properly inserted into the key cylinder.

### 2. Descriptions of Related Art

The conventional key 1 as disclosed in FIG. 1 includes a shank 10 and a handle portion 11, wherein the key 1 is made by metal and the handle portion 11 is coated with plastic material. When using the key 1 to lock or unlock a lock, the shank 10 is inserted into the lock cylinder 21 via the keyhole 210 of the lock 20. The shank 10 of the key 1 has multiple grooves 100 which are located corresponding to the pins or the like of the lock cylinder 21 so that the key 1 is rotated to lock or unlock the lock. Generally, the shank 10 of the key 1 is expected to be inserted into the lock cylinder 21 to the inner end of the lock cylinder 21 such that the grooves 100 of the shank 10 of the key 1 are located corresponding to the pins or the like of the lock cylinder 21, In other words, if the shank 10 of the key 1 does not reach the expected position in the lock cylinder 21, the key 1 cannot successfully rotated, and the shank 10 may damage or deform the pins or the like of the lock cylinder 21.

The present invention intends to provide a key assembly to eliminate the shortcomings mentioned above.

### SUMMARY OF THE INVENTION

The present invention relates to a key assembly and comprises a shank and a handle portion, wherein the handle portion includes a free end and a connection end from which the shank extends. The shank includes multiple grooves, A tubular portion is connected to the connection end of the handle portion and a portion of the shank is accommodated in the tubular portion. The length from the distal end of the tubular portion to the distal end of the shank is the same as the depth from the key hole to the inner bottom of a lock cylinder.

Preferably, a key coat is mounted to the key assembly and made of plastic. The key coat includes a head and the tubular portion extends from the head. A room is defined in the head of the key coat and opens through one end that is opposite the tubular portion. A passage is defined through the tubular portion and communicates with the room. A portion of the handle portion is accommodated in the room.

The primary object of the present invention is to provide a key assembly wherein a key coat is mounted to a portion of the shank of the key so that the distal end of the key coat contacts the lock to acknowledge the user that the shank of the key assembly is properly inserted into the lock cylinder.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows that a conventional key is inserted into a lock cylinder of a lock;

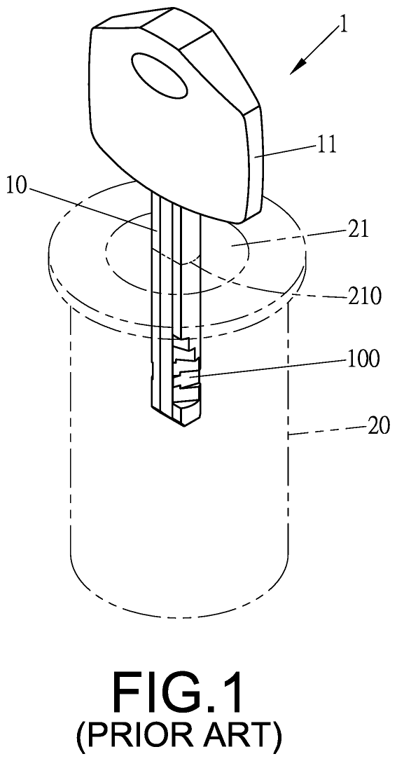

FIG. 2 is an exploded view to show the key assembly of the present invention;

FIG. 3 is a perspective view to show the key assembly of the present invention;

FIG. 4 is a cross sectional view of the key assembly of the present invention, and

FIG. 5 shows that the key assembly is inserted into a lock cylinder of a lock, and the distal end of the key coat contacts the lock.

### DETAILED DESCRIPTION OF THE PREFERRED EMBODIMENT

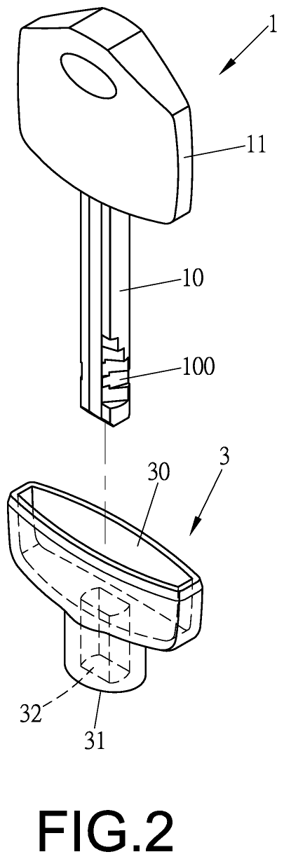

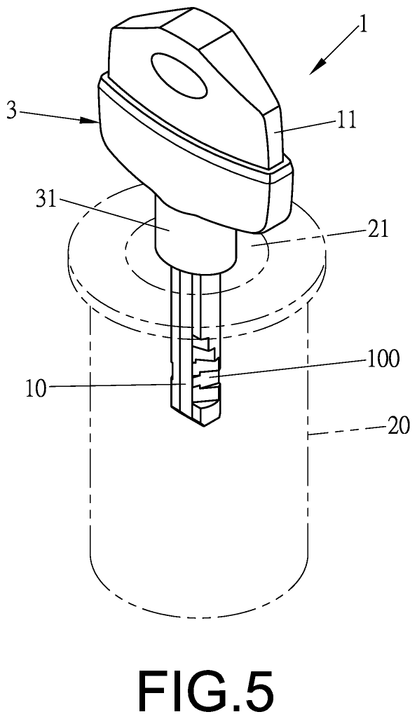

Referring to FIG. 2, the key assembly 1 of the present invention comprises a shank 10 and a handle portion 11. The handle portion 11 is made of plastic and includes a free end and a connection end from which the shank 10 extends. The shank 10 includes multiple grooves 100 which are designed to be engaged with pins or the like of a lock cylinder 21 of a lock 20 as shown in FIG. 5.

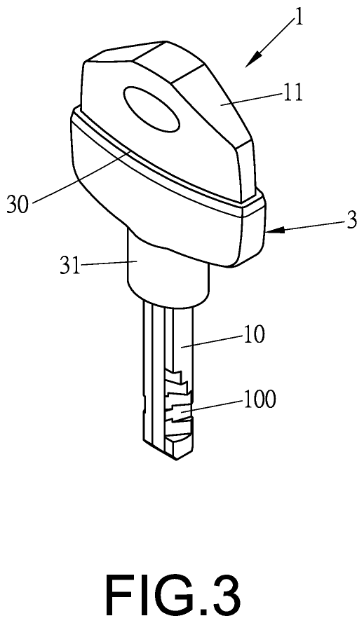

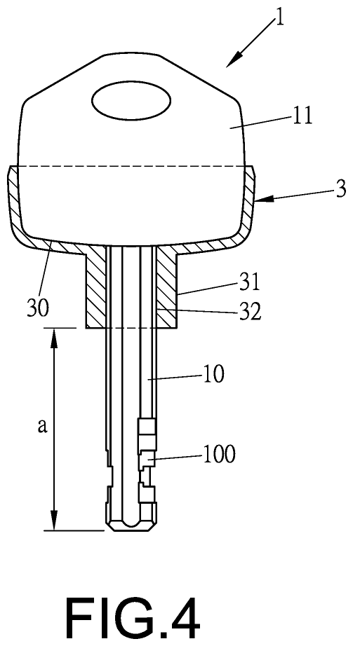

As shown in FIGS. 3 and 4, a key coat 3 is mounted to the key assembly and made of plastic. The key coat 3 includes a head and a tubular portion 31 that extends from the head. A room 30 is defined in the head of the key coat 3 and opens through one end that is opposite the tubular portion 31. A passage 32 is defined through the tubular portion 31 and communicates with the room 30. A portion of the handle portion 11 is accommodated in the room 30, and a portion of the shank 10 accommodated in the tubular portion 31.

When in use, as shown in FIGS. 3 to 5, the shank 10 of the key assembly 1 is inserted into the lock cylinder 21 of the lock 20 via the key hole 210. It is noted that the length “a” from the distal end of the tubular portion 31 to the distal end of the shank 10 the same as the depth from the key hole 210 to the inner bottom of the lock cylinder 21. In other words, when the shank 10 of the lock assembly 1 is inserted into the lock cylinder 21 and reaches the inner bottom of the lock cylinder 21. The users are acknowledged when the distal end of the tubular portion 31 contacts the lock 20 as shown in FIG. 5. The grooves 100 of the shank 10 of the key assembly 1 are engaged perfectly with the pin or the like in the key lock 21. The key assembly 1 is then able to rotate without damaging any components in the lock cylinder 21.

The key assembly 1 of the present invention makes the use of the key assembly 1 without need of try and error between the shank 10 and the lock cylinder 21. It is easier to use the key assembly when compared with the conventional keys.

While we have shown and described the embodiment in accordance with the present invention, it should be clear to those skilled in the art that further embodiments may be made without departing from the scope of the present invention.

What is claimed is:

1. A key assembly comprising:
a shank and a handle portion, the handle portion having a free end and a connection end from which the shank extends, the shank including multiple grooves, a tubular portion connected to the connection end of the handle portion and a portion of the shank accommodated in the tubular portion, a length from a distal end of the tubular portion to a distal end of the shank being adapted to be the same as a depth from a key hole to an inner bottom of a lock cylinder.

2. The key assembly as claimed in claim 1, wherein a key coat is mounted to the key assembly, the key coat includes a head, and the tubular portion extends from the head, a room is defined in the head of the key coat and opens through one end that is opposite the tubular portion, a passage defined through the tubular portion and communicates with the room, a portion of the handle portion is accommodated in the room.
